(19) United States
(12) Patent Application Publication
(10) Pub. No.: US 2006/0205375 A1
(43) Pub. Date: Sep. 14, 2006

(54) Measurement circuit and method for measuring the level of an RF signal, and a transmitter including a measurement circuit

(75) Inventor: Risto Vaisanen, Salo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/077,992

(22) Filed: Mar. 11, 2005

(51) Int. Cl. H04K 3/00; G01S 7/42; H04B 7/00; H04B 1/06; G01S 7/36

(52) U.S. Cl. 455/276.1; 455/273

(57) ABSTRACT

A measurement circuit for measuring a level of a radio frequency signal comprises a first signal path adapted to conduct a first version of a radio frequency signal and a second signal path adapted to conduct a second version of said radio frequency signal. The first and second versions have different phases. A combining circuit (301, 302, 405, 406, 407, 501, 502, 503, 605, 606, 607, 608, 609, 610, 801, 802) is coupled to receive the first version and the second version of the radio frequency signal. The combining circuit comprises a phase shifter part (301, 405, 406, 605, 606, 607, 801) adapted to change the phase of at least one of the first version and the second version of the radio frequency signal to make the phases of the first version and the second version equal, and an adder part (302, 407) adapted to produce a sum of the first version and the second version the phases of which were made equal, the sum being indicative of the level of the radio frequency signal.

### TECHNICAL FIELD

The invention concerns the technical field of producing controlled radio frequency (RF) transmissions. Especially the invention concerns the technology of measuring a level of an RF signal.

### BACKGROUND OF THE INVENTION

Measuring the level of an RF signal to be transmitted is important in transmitter devices that have a controllable amplifier section with variable gain, because accurately measuring the level of an amplified RF signal enables controlling the gain of the amplifier section so that it is at an optimal value at all times. In addition to the plain output power coming out of the last amplifier stage, the levels of various reflected signals are of interest. For example, an impedance mismatch somewhere between the power amplifier output and the antenna of a radio device causes reflections, which are unavoidable in the sense that even if perfect impedance matching at standalone conditions could be achieved, the position of the user's hand as well as the presence of conductive objects near the antenna change its impedance in practically unpredictable ways.

In known WCDMA- and CDMA-based cellular systems a base station measures the level of a signal received from a mobile station and uses the measurement as a basis for giving power control commands to the mobile station. The mobile station in turn may have a duty to report, how much margin it has left for increasing its transmission power, so that the system can timely prepare for handing the connection over to another base station or even to change it from one system to another, for example from WCDMA to GSM.

These considerations make it necessary to make accurate power level measurements in the mobile stations. The transmission power level measurement results may have also additional applications in a transmitting radio device, such as controlling the biasing of power amplifiers. Also the results of measuring reflected signal power may have numerous applications.

A conventional way of measuring RF signal levels involves using a directional coupler, which typically consists of two transmission lines near enough each other so that electromagnetic coupling occurs between them. One of the transmission lines conducts the RF signal to be measured, which induces a signal also to the other. The measurement coupling may comprise a terminating impedance at one end of the second transmission line and a detector at the other, or some other kinds of known couplings.

A major drawback of directional couplers is that they are difficult to implement in reasonable space into an integrated RF circuit. Trying to miniaturize a directional coupler leads usually to unacceptably high losses, poor directivity, too narrow bandwidth and other problems. Transformer type alternatives are known, with inductances and capacitances instead of transmission lines, but they share the same drawbacks related to large space requirements and other difficulties in integrating with other circuit elements.

FIG. 1 illustrates certain parts of a prior art transmitter device. The integrated RF circuitry comprises an active part 101 and a passive part 102. Within the active part 101 a radio frequency signal to be transmitted is conducted to a phasing part 103, which produces two versions of the radio frequency signal: a direct phase signal and another having a 90 degrees phase difference. These are separately coupled to the inputs of two parallel controllable amplifiers 104 and 105, which thus produce amplified in-phase and quadrature-phase versions of the radio frequency signal. The differently phased versions are combined in a so-called 3 dB hybrid 106, one output of which is terminated with a terminating impedance 107 while the other is coupled through a low-pass filter 108 and a directional coupler 109 to a load 110. The 3 dB hybrid 106, the terminating impedance 107, the low-pass filter 108 and the directional coupler 109 are located within the passive part 102.

The combination of two parallel amplifier stages operating at a 90 degrees phase difference and a combiner is often misleadingly designated as a balanced amplifier, which may cause confusion with a similarly designated differential amplifier, where the phase difference is 180 degrees. Using two parallel, differently phased amplifier stages helps to cope with the unpredictably changing impedance encountered e.g. in the case where the load 110 is the antenna of a hand-held radio device. In a more traditional and more straightforward structure there would be no phasing part 103 or 3 dB hybrid 106, and only a single amplifier stage with an output coupled through a low-pass filter to the directional coupler.

In order to utilise the signal level information available at the directional coupler 109 there are detectors 111 and 112, which are located within the active part 101 and produce indications about the levels of the signals passing through the directional coupler 109, most importantly the output power level of the two-stage amplifier section. The location of the directional coupler 109 in the passive part 102 and the detectors 111 and 112 in the active part 101 necessitates additional connections between the passive and active parts, which is a drawback. To utilize the indications produced by the detectors 111 and 112 their outputs (designated as Vu and Vn in the drawing) are typically conducted to a control circuit, which in turn produces a control voltage Vc which controls the operation of the amplifiers through a controllable voltage source 113.

Attempts have been made to determine the power level of a signal to be transmitted also without a directional coupler, in some indirect way. Such attempts include measuring e.g. the DC power at the power amplifier, the bias current or the input signal level and trying to make deductions about the power levels at the output. The accuracy of such indirect measurements has been modest at its best.

FIG. 2 illustrates a prior art solution known from the publication U.S. Pat. No. 5,252,929. The output of a power amplifier section 201 is coupled to a phase shifter 202, which produces a phase shift. From the viewpoint of the actual transmission available at the output of the phase shifter 202 the phase shift has little meaning, but it can be used for the purpose of approximate power level measurements. A first version of the radio frequency signal to be transmitted is taken before the phase shifter 202 and coupled through a first capacitance 203 to a first detector 204. A second, differently phased version of the radio frequency signal to be transmitted is taken after the phase shifter 202 and coupled through a second capacitance 205 to a second detector 206. The outputs of the first and second detectors 204 and 206 are summed in an adder 207, the output of which is coupled to the control circuit 208 which controls the amplification of the power amplifier section 201 through a controllable voltage source 209. The drawback of the known solution of FIG. 2 is that it gives inaccurate results especially in cases where the load impedance varies.

### SUMMARY OF THE INVENTION

The present invention aims at presenting a method and a measurement circuit for measuring the level of an RF signal, especially so that the accuracy of the measurement is good also under varying load impedance conditions. The invention aims also at presenting a solution which is easily applicable for integration with other RF circuits. Additionally the invention aims at presenting a transmitter device in which the method and measurement circuit are utilized to optimize the structure and operation of the device.

The objectives of the invention are achieved by taking two versions of the RF signal with a phase difference between them, changing the phase of at least of said two versions so that they become equal (and/or opposite) in phase, producing a combination thereof and using said combination as an indication of the required RF signal level.

A measurement circuit according to the invention comprises a first signal path adapted to conduct a first version of a radio frequency signal, said first version having a first phase, a second signal path adapted to conduct a second version of said radio frequency signal, said second version having a second phase different than said first phase, and a combining circuit coupled to receive said first version and said second version of said radio frequency signal. Said combining circuit comprises a phase shifter part adapted to change the phase of at least one of said first version and said second version of said radio frequency signal to make the phases of said first version and said second version equal, and an adder part adapted to produce a sum of said first version and said second version the phases of which were made equal, said sum being indicative of said level of said radio frequency signal.

The invention applies also to a transmitter device, which comprises an amplifier section adapted to produce a radio frequency signal, an output circuit coupled to conduct said radio frequency signal to a load, said output circuit comprising a first signal path and a second signal path, a measurement circuit adapted to measure a level of said radio frequency signal and a control circuit adapted to control the level of the radio frequency signal produced by said amplifier section on the basis of a measurement made by said measurement circuit. Said measurement circuit is coupled to receive differently phased versions of the radio frequency signal from said first signal path and said second signal path and adapted to make said differently phased versions equal in phase and to produce a sum of said differently phased versions made equal in phase, and said control circuit is coupled to receive a signal indicative of the magnitude of said sum.

Additionally the invention applies to a method, which comprises:

receiving a first version of a radio frequency signal, said first version having a first phase,

receiving a second version of said radio frequency signal, said second version having a second phase different than said first phase,

changing the phase of at least one of said first version and said second version of said radio frequency signal to make the phases of said first version and said second version equal, and

producing a sum of said first version and said second version the phases of which were made equal, as an indication of said level of said radio frequency signal.

Additionally the invention applies to a power amplifier module for use in a transmitter device, which comprises an amplifier section adapted to produce a radio frequency signal, a phase shifter part coupled to receive two differently phased versions of said radio frequency signal and adapted to make said differently phased versions equal in phase and to produce a sum of said differently phased versions made equal in phase, and a detector coupled to receive said sum and adapted to produce a signal indicative of a magnitude of said sum.

Two versions of an RF signal to be transmitted are available for example at different sides of a phase shifter or at the outputs of the parallelly operating amplifiers of a so-called balanced amplifier. If these are taken through a phase equalizing circuit to make them equal (or opposite) in phase, important information about the level of the original signal can be obtained by combining the resulting equally (or oppositely) phased signal versions. In a clear contrast to the known solution of U.S. Pat. No. 5,252,929, which destroys the information encoded in the phase angle characteristics, the method and circuit of the present invention makes it possible to maintain the accuracy of the measurement even if the load impedance changes.

Making the differently phased signal versions equal in phase and combining these equally phased versions reveals information about the power of a transmitted signal. Making the differently phased signal versions opposite in phase and combining these oppositely phased versions reveals information about the power of a reflected signal. These measurements can be easily combined so that the resulting versatile measurement circuit enables monitoring both the transmitted and reflected signal components. The circuit elements that are required for a physical implementation are easily implemented both in integrated RF circuits and in discrete component solutions, which makes the invention widely applicable in many kinds of different transmitter device architectures.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a known solution based on a directional coupler,

FIG. 2 illustrates a known solution based on a phase shifter and two detectors,

FIG. 3 illustrates a principle according to an embodiment of the present invention,

FIG. 4 illustrated a more practically oriented example of an embodiment of the invention,

FIG. 5 illustrates a further embodiment of the invention,

FIG. 6 illustrates a possible practical implementation of an embodiment of the invention,

FIG. 7 illustrates a further advantageous embodiment of the invention,

FIG. 8 illustrates a further advantageous embodiment of the invention,

FIG. 9 illustrates a transmitter device according to an embodiment of the invention and

FIG. 10 illustrates yet another advantageous embodiment of the invention.

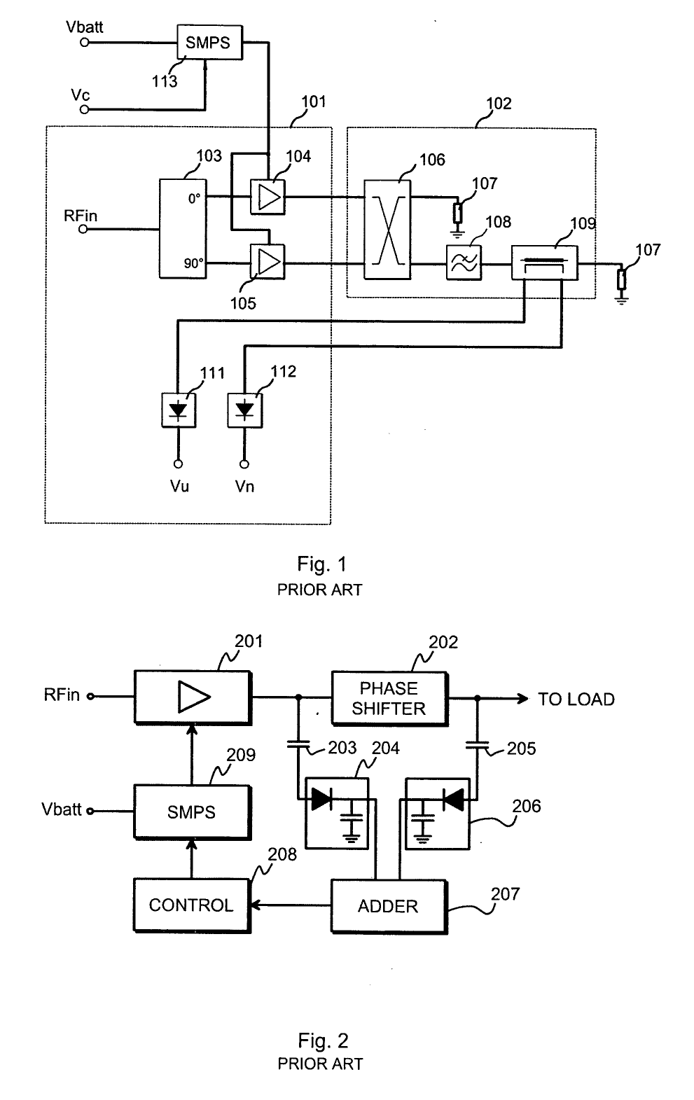

### DETAILED DESCRIPTION OF ADVANTAGEOUS EMBODIMENTS OF THE INVENTION

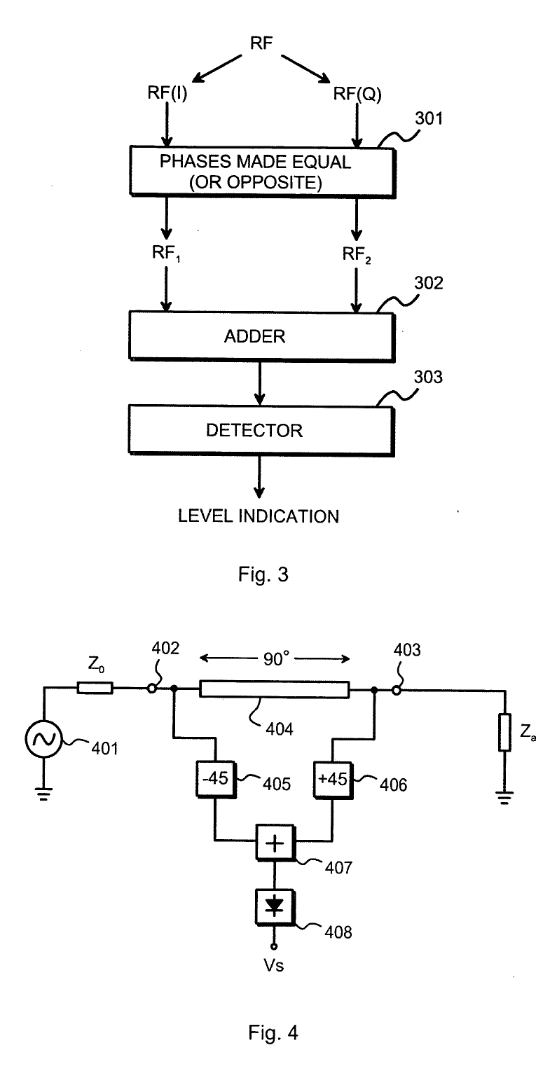

In FIG. 3 we assume that there exist two versions of an radio frequency signal RF, the essential difference between the two versions being a phase difference. For maximizing the accuracy of the measurement in a measurement circuit according to the invention, the magnitude of said phase difference is most advantageously 90 degrees. Thus the two signal versions can be designated as the in-phase signal version RF(I) and the quadrature signal version RF(Q). It is possible to apply the measurement principle according to the invention even if the phase difference is something else, but the accuracy of the measurement will not be as good.

No specific assumptions need to be made of the original radio frequency signal RF; in general we may assume that it is some radio frequency signal to be transmitted, which may include both forward direction and backward direction (=reflected) components.

The phase of at least one of the signal versions is changed in a phase shifter part 301 so that as a result there are still two versions of the RF signal but in equal phase. Later we will consider separately the possibility of making the RF signal versions opposite in phase instead. The two versions RF₁ and RF₂ that are equal (or opposite) in phase are summed in an adder 302 and the resuiting sum is detected in a detector 303. The output of the detector 303 can be used as an indicator of a power level of the original radio frequency signal RF.

Exactly what characteristic of the original radio frequency signal RF the output of the detector reflects depends on whether the phases of the two versions RF₁ and RF₂ were made equal or opposite. We may consider the more practical example of FIG. 4, in which a figuratively described signal generator 401 is adapted to generate a radio frequency signal and to have an output impedance Z₀. The radio frequency signal generated by the signal generator 401 is conducted through a load, which may be for example an antenna and which has a load impedance Zₐ. Between the signal generator 401 and the load there is a measurement circuit having an input 402 and an output 403. Coupled therebetween is a phase shifter, which in FIG. 4 is schematically illustrated as a 90 degrees transmission line 404. In order not to cause confusion with designations we may designate the transmission line 404 as the “transmission phase shifter”, because it causes a phase shift to the radio frequency transmission.

We may assume that the transmission line 404 is perfectly matched to the output of the signal generator 401; in other words the impedance of the transmission line 404 is equal to Z₀. On the other hand the load impedance Zₐ may vary, for example if a user places his hand near to an antenna that acts as a load, or if a conductive object comes near the antenna. The reflection factor K may be calculated as

$$K = \frac{{Z}_{a} - {Z}_{0}}{{Z}_{a} + {Z}_{0}} . \qquad ( 1 )$$

In this exemplary case we assume that the load impedance Zₐ is smaller than Z₀, so there is a voltage maximum Vₘₐₓ at the input end of the transmission line 404 and correspondingly a voltage minimum Vₘᵢₙ at the output end thereof. These can be expressed with the help of the reflection factor K as
Vₘₐₓ=V₀·(1+|K|) (2)
Vₘᵢₙ=V₀(1−|K|) (3)
Where V₀ refers to the basic voltage of the signal generator output. The radio frequency signal at the input 402 constitutes the first (in-phase) version of the radio frequency signal. Similarly the radio frequency signal at the output 403 constitutes the second (quadrature) version of the radio frequency signal. The first and second versions are taken to a phase shifter part which here consists of a pair of complementary phase shifters: the first 405 of the pair produces a −45 degrees phase shift, and the second 406 of the pair produces a +45 degrees phase shift. As a result, the two versions of the radio frequency signal have equal phases when they come to an adder 407.

The sum produced at the adder 407 is
V₀·(1+|K|)+V₀·(1−|K|)=2V₀, (4)
which does not depend on the reflection factor K at all but only on the level of the original radio frequency signal generated by the signal generator 401. We may deduce that an impedance mismatch between the signal generator 401 and the load does not affect the detection result Vs produced at the detector 408, which is indicative of the magnitude of the sum produced at the adder 407.

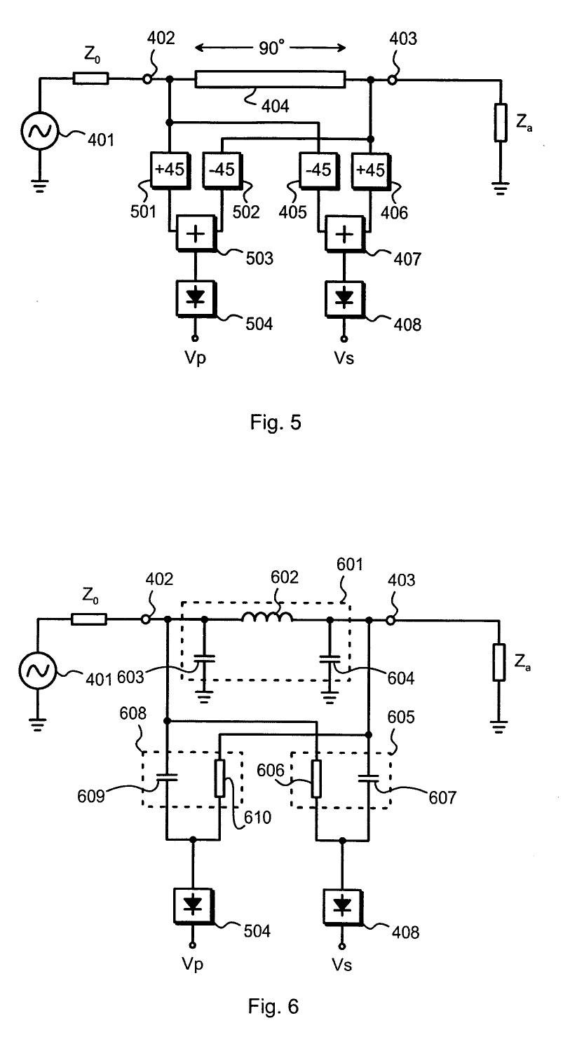

FIG. 5 illustrates the apparatus of FIG. 4 augmented with a further phase shifter part, which consists of a +45 degrees phase shifter 501 coupled to receive the first (in-phase) version of the radio frequency signal and a −45 degrees phase shifter 502 coupled to receive the second (quadrature) version of the radio frequency signal. As a result, the two versions of the radio frequency signal have opposite phases when they come to an adder 503.

The sum produced at the adder 503 is
V₀·(1+|K|)+[−V₀·(1−|K|)]=2KV₀, (5)
which depends on the reflection factor K. Thus the detection result Vp produced at the detector 504, which is indicative of the magnitude of the sum produced at the adder 503, reflects the amount of mismatch between the signal generator 401 and the load. At a perfect impedance matching situation the generator and load impedances are equal (Z₀=Zₐ) and the reflection factor K is zero, which means that also the detection result Vp is zero. If the detectors 408 and 504 are adapted to produce commensurate results, a ratio Vp/Vs gives directly the reflection factor K.

The mathematical expressions presented above are somewhat simplified versions of a complete mathematical analysis which should take into account e.g. the fact that the impedances involved may not be purely resistive. However, they serve well to illustrate the applicability of the invention. For a person skilled in the art it would be straightforward to generalize the mathematical treatment to a more generally applicable form that accommodates arbitrary (even capacitive and/or inductive) impedance values.

FIG. 6 illustrates a practical implementation of a measurement circuit according to the principle of FIG. 5. The transmission phase shifter 601 comprises a serially coupled inductor 602 with capacitances 603 and 604 coupled from each terminal of the inductor 602 to ground. The phase shifter part 605 comprises a first resistance 606, a first terminal of which is coupled to the input 402 of the measurement circuit to receive the first (in-phase) version of the radio frequency signal, and a first capacitance 607, a first terminal of which is coupled to the output 403 f the measurement circuit to receive the second (quadrature) version of the radio frequency signal. The “adder” function illustrated in the previous drawings is simply a connection between the second terminals of the first resistance 606 and the first capacitance 607.

Similarly the further phase shifter part 608 comprises a second capacitance 609, a first terminal of which is coupled to the input 402, and a second resistance 610, a first terminal of which is coupled to the output 403. Also here the “adder” function is simply a connection between the second terminals of the second capacitance 609 and the second resistance 610.

It should be noted that a phase shifter part (or a further phase shifter part) which in the foregoing are illustrated as a pair of +45 and −45 phase shifters is only an exemplary way of producing equally (or oppositely) phased versions of the radio frequency signal; any alternatives are possible, like having phase shifters of +30 and −60 degrees or +10 and −80 degrees, up to the obvious limiting case of producing a full phase shift of an absolute magnitude of 90 degrees to one while leaving the phase of the other untouched. However, as is seen in the exemplary practical implementation of FIG. 6, the “pair of +45 and −45 phase shifters” solution is especially easy to build in practice, only requiring one capacitance and one resistance.

The component values for the components of a practical implementation for example like that of FIG. 6 are easy to determine for a person skilled in the art. For the sake of completeness we present here the theoretical values that might be used in the case of FIG. 6 as a starting point for fine tuning that takes into account the effect of stray capacitances and inductances. Assuming that the output impedance of the signal generator 401 is Z₀ and the transmission frequency is f, the theoretical inductance L of the inductor 602 is

$$L = \frac{{Z}_{0}}{2 π f} \qquad ( 6 )$$

and the equal capacitance values C of the capacitances 603 and 604 are

$$C = \frac{1}{2 π {fZ}_{0}} . \qquad ( 7 )$$

The resistance values of the first and second resistors 606 and 610 are selected large enough so that the measurement circuit does not load too much the signal to be transmitted, but simultaneously small enough to get a representative sample of the signal. After having determined suitable resistance values R1 and R2 the capacitance values C1 and C2 of the first and second capacitances 607 and 609 are calculated as

$$\begin{matrix}C 1 = \frac{1}{2 π fR 1} & ( 8 ) \\ and & \\ C 2 = \frac{1}{2 π fR 2} . & ( 9 )\end{matrix}$$

The invention does not limit the implementation of the detectors 408 and 504. Any suitable detectors can be used, including but not being limited to diode detectors, detectors implemented with a mixer and a phaser or detectors based on a logarithmic amplifiers. Similarly the implementations of phasing and summing functions that have been shown based on completely passive components are exemplary only; a variety of alternative ways, including the use of active components, exist and are known for implementing similar functions.

It should be noted that using a transmission phase shifter to produce two differently phased versions of a single radio frequency signal is not the only possibility where the invention can be applied. FIG. 7 illustrates a transmitter device where the radio frequency circuitry is located in an active part 701 and a passive part 702, which can be e.g. parts of an integrated RF circuit. Within the active part 701 a radio frequency signal to be transmitted is brought through an input port 703 to a phasing part 704, which produces a first (in-phase) version and a second (quadrature) version of the radio frequency signal, with a 90 degrees phase difference between them. The first and second versions of the radio frequency signal are amplified in parallel controllable amplifier stages 705 and 706 respectively; the gain of the parallel controllable amplifier stages 705 and 706 is controlled with a signal brought from a control circuit (not shown in FIG. 7) to a control input 707.

Within the passive part 702 there is a 3 dB hybrid 708 that receives the amplified first and second versions of the radio frequency signal. One output of the 3 dB hybrid 708 is coupled to ground through a terminating resistance 709, while the other is coupled through a low-pass filter 710 to an output port 711 and therethrough to e.g. a transmission cable or an antenna (not shown).

The measurement circuit according to an embodiment of the invention has two inputs 712 and 713, one of which is coupled to receive the amplified first (in-phase) version of the radio frequency signal while the other is coupled to receive the amplified second (quadrature) version of the radio frequency signal. In accordance to the descriptions presented earlier, a phase shifter part 405-406, an adder part 407 and a detector 408 are adapted to produce a signal Vs indicative of the power level of the transmitted signal, and a further phase shifter part 501-502, a further adder part 503 and a further detector 504 are adapted to produce a signal Vp indicative of the power level of the reflected signal.

Losses are easily kept at a lower level in a circuit and transmitter device according to the invention than the losses in conventional solutions based on directional couplers. At the transistors of a power amplifier the output impedance is usually relatively low, which means that connections from there to a measurement circuit according to the invention load the payload signal path much less than if the measurement was accomplished closer to the antenna. Not having to conduct any measurement signals outside the immediate vicinity of the power amplifier stage (i.e. outside the active part of an RF integrated circuit) means that the level of the signal drawn by the measurement is very low; in other words the measurement circuit only has to take a very small fraction of the payload signal as a sample.

Using controllable power amplifier stages with variable gain is not the only possibility of controlling the transmission power of a radio device. If the power amplifier stage(s) is (are) linear, it is possible to control the level of the RF signal coming to the input(s) of the power amplifier stage(s) and make the latter operate with constant gain. Also a combination of a controlling the level of the RF signal at said input(s) and controlling the gain of the power amplifier stage(s) is possible. Various other ways for controlling the level of the signal to be transmitted are known and applicable for use in combination with the level measuring arrangement according to the invention.

Similarly it is not important to the invention that there are parallel amplifiers 705 and 706; any outputting circuit elements that produce suitably phase shifted versions of an RF signal would do quite as well.

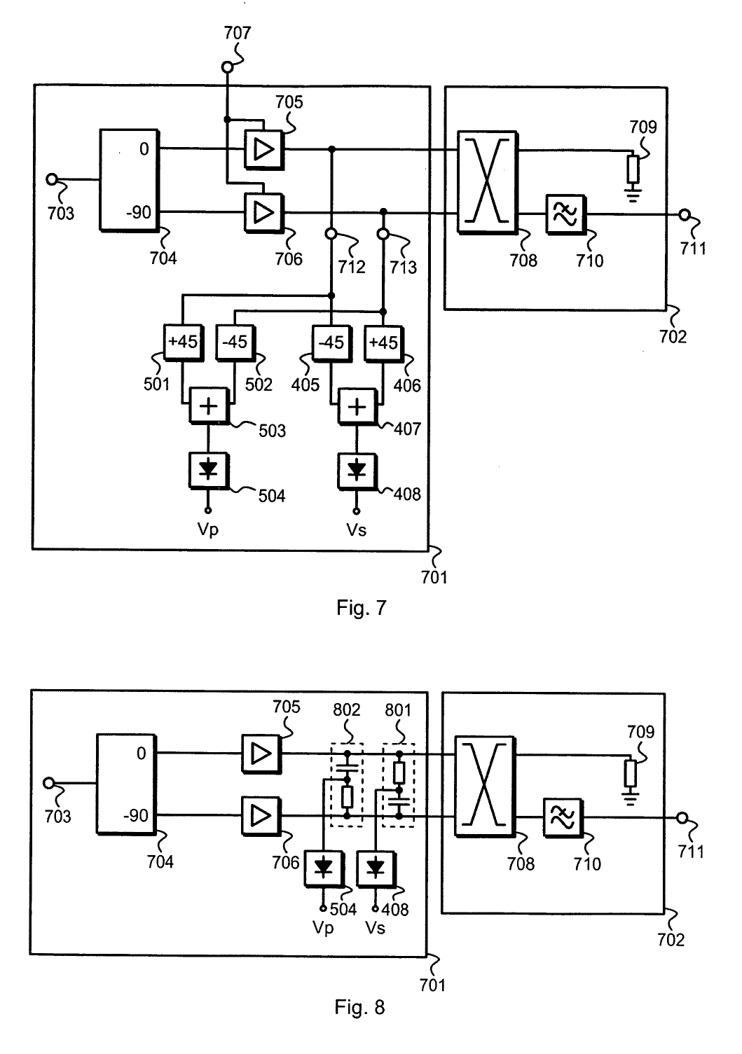

FIG. 8 illustrates an exemplary practical implementation of the principle of FIG. 7. In order to realize the required phase shifts and adding, there is a series coupling 801 of a resistance and a capacitance from the output of the “inphase” amplifier stage 705 to the output of the “quadrature” amplifier stage 706 and a series coupling 802 of a resistance and a capacitance from the output of the “quadrature” amplifier stage 706 to the output of the “in-phase” amplifier stage 705. A coupling to the detector 408 adapted to produce the Vs signal is made from between the resistance and the capacitance in the first-mentioned series coupling 801, and a coupling to the further detector 504 adapted to produce the Vp signal is made from between the capacitance and the resistance in the latter series coupling 802.

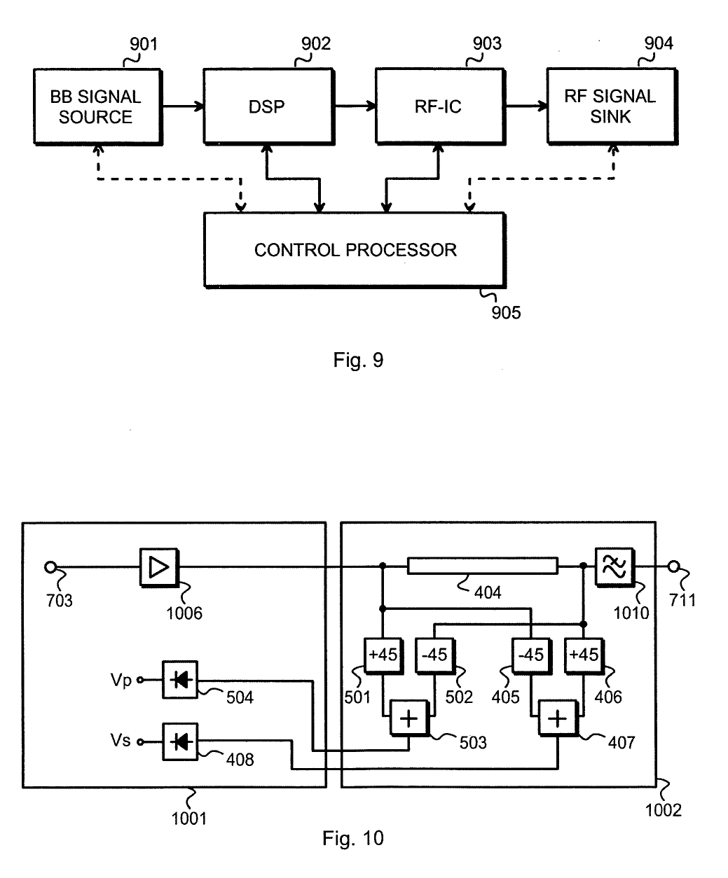

FIG. 9 illustrates schematically a transmitter device according to an embodiment of the invention. Signals to be transmitted originate in a baseband signal source 901, and baseband processing such a source encoding and channel encoding are accomplished in a digital signal processor 902. Digital to analog conversion, modulation, amplification and filtering are accomplished in a radio frequency integrated circuit 903 and the RF signals to be transmitted are delivered to an RF signal sink 904, which may be e.g. an antenna or a cable connection. A control block 905 is adapted to control at least the baseband processing in the digital signal processor 902 and the RF processing in the radio frequency integrated circuit 903. There may be some control connections also between the control block 905 and the baseband signal source 901 and/or the RF signal sink 904.

In the architecture of FIG. 9 a measurement circuit according to an embodiment would most naturally be located within the radio frequency integrated circuit 903. The signal(s) produced by it, which signals are indicative of the measured level(s) of the radio frequency signal(s), may be handled internally within the radio frequency integrated circuit 903 or they can be coupled to the control block 905, which uses them to control the operation of at least one of the digital signal processor 902 and the radio frequency integrated circuit 903. Comparing to FIG. 7, this means that there would be connections between the active part 701 illustrated in FIG. 7 and the control block 905 illustrated in FIG. 9, so that the latter is adapted to receive the Vs and Vp signals and to produce the control signal which (or a derivative of which) the active part 701 would receive through the control input 707.

Various modifications to the above-explained exemplary embodiments are possible. For example, it is possible to use the “unipolar” principle of FIG. 4 in an RF integrated circuit. FIG. 10 illustrates an arrangement in which the active part 1001 of an RF integrated circuit comprises an amplifier 1006 having an input 703. From the amplifier 1006 the amplified signal is conducted to the passive part 1002 of the RF integrated circuit, which may include e.g. filters 1010. According to an embodiment of the invention the passive part 1002 also includes a transmission phase shifter 404 and, coupled to receive signals from both sides thereof, a phase shifter part 405, 406 and an adder part 407, as well as a further phase shifter part 501, 502 and a further adder part 503. These are adapted to operate according to the principle explained earlier in association with FIGS. 4 and 5, so that the summed output signals can be conducted back to the active part 1001, where detectors 408 and 504 are adapted to produce the Vs and Vp signals respectively.

The components illustrated in the drawings may be implemented with lumped circuit elements or in a more distributed manner.

The invention is adaptable to radio devices designed in a modular way, so that for example a power amplifier module according to the invention comprises the components illustrated within the active part 701 of FIG. 7 and/or FIG. 8.

What is claimed is:

1. A measurement circuit for measuring a level of a radio frequency signal, comprising:
a first signal path adapted to conduct a first version of a radio frequency signal, said first version having a first phase,
a second signal path adapted to conduct a second version of said radio frequency signal, said second version having a second phase different than said first phase, and
a combining circuit coupled to receive said first version and said second version of said radio frequency signal,
wherein said combining circuit comprises a phase shifter part adapted to change the phase of at least one of said first version and said second version of said radio frequency signal to make the phases of said first version and said second version equal, and an adder part adapted to produce a sum of said first version and said second version the phases of which were made equal, said sum being indicative of said level of said radio frequency signal.

2. The measurement circuit according to claim 1, comprising:
an input adapted to receive said radio frequency signal,
an output and
a transmission phase shifter coupled between said input and said output to conduct said radio frequency signal from said input to said output,
wherein a signal path from said input to said transmission phase shifter constitutes said first signal path and a signal path from said transmission phase shifter to said output constitutes said second signal path.

3. The measurement circuit according to claim 1, comprising:
a first input adapted to receive a radio frequency signal from a first outputting circuit element and
a second input adapted to receive a radio frequency signal from a second outputting circuit element,
wherein a signal path from said first input to said phase shifter part constitutes said first signal path and a signal path from said second input to said phase shifter part constitutes said second signal path.

4. The measurement circuit according to claim 1, wherein said phase shifter part comprises a first half of a pair of complementary phase shifters and a second half of said pair of complementary phase shifters, of which said first half is coupled to receive said first version of said radio frequency signal and said second half is coupled to receive said second version of said radio frequency signal, and said first half and said second half are adapted to produce phase shifts of such magnitude that a sum of the absolute values of said phase shifts is equal to the phase difference between the first and second versions of said radio frequency signal.

5. The measurement circuit according to claim 4, wherein each of said first half and said second half is adapted to produce a phase shift of an absolute magnitude of 45 degrees.

6. The measurement circuit according to claim 1, wherein said combining circuit comprises a further phase shifter part adapted to change the phase of at least one of said first version and said second version of said radio frequency signal to make the phases of said first version and said second version opposite, and a further adder part adapted to produce a sum of said first version and said second version the phases of which were made opposite, said sum being indicative of an other characteristic of said radio frequency signal than said level.

7. The measurement circuit according to claim 6, wherein:
said phase shifter part comprises a first resistance, a first terminal of which is coupled to receive said first version of said radio frequency signal, and a first capacitance, a first terminal of which is coupled to receive said second version of said radio frequency signal, and a connection between the second terminals of said first resistance and said first capacitance, and
said further phase shifter part comprises a second capacitance, a first terminal of which is coupled to receive said first version of said radio frequency signal, and a second resistance, a first terminal of which is coupled to receive said second version of said radio frequency signal, and a connection between the second terminals of said second capacitance and said second resistance.

8. A transmitter device for transmitting a radio frequency signal, comprising:
an amplifier section adapted to produce a radio frequency signal,
an output circuit coupled to conduct said radio frequency signal to a load, said output circuit comprising a first signal path and a second signal path,
a measurement circuit adapted to measure a level of said radio frequency signal and
a control circuit adapted to control the level of the radio frequency signal produced by said amplifier section on the basis of a measurement made by said measurement circuit;
wherein said measurement circuit is coupled to receive differently phased versions of the radio frequency signal from said first signal path and said second signal path and adapted to make said differently phased versions equal in phase and to produce a sum of said differently phased versions made equal in phase, and said control circuit is coupled to receive a signal indicative of the magnitude of said sum.

9. The transmitter device according to claim 8, wherein said output circuit comprises a transmission phase shifter, and said first signal path couples an output of said amplifier section to said transmission phase shifter and said second signal path couples said transmission phase shifter to said load.

10. The transmitter device according to claim 9, wherein said transmission phase shifter is a 90 degrees phase shifter.

11. The transmitter device according to claim 8, wherein:
said amplifier section comprises two parallel amplifier stages,
said output circuit comprises a combiner, and
said first signal path couples an output of one of said parallel amplifier stages to said combiner and said second signal path couples an output of another of said parallel amplifier stages to said combiner.

12. The transmitter device according to claim 8, wherein said measurement circuit is additionally adapted to make said differently phased versions opposite in phase and to produce a sum of said differently phased versions made opposite in phase, and said control circuit is coupled to receive also said sum of said differently phased versions made opposite in phase.

13. A method for measuring a level of a radio frequency signal, comprising:
receiving a first version of a radio frequency signal, said first version having a first phase,
receiving a second version of said radio frequency signal, said second version having a second phase different than said first phase,
changing the phase of at least one of said first version and said second version of said radio frequency signal to make the phases of said first version and said second version equal, and
producing a sum of said first version and said second version the phases of which were made equal, as an indication of said level of said radio frequency signal.

14. A power amplifier module for use in a transmitter device, comprising:
an amplifier section adapted to produce a radio frequency signal,
a phase shifter part coupled to receive two differently phased versions of said radio frequency signal and adapted to make said differently phased versions equal in phase and to produce a sum of said differently phased versions made equal in phase, and
a detector coupled to receive said sum and adapted to produce a signal indicative of a magnitude of said sum.

15. The power amplifier module according to claim 14, comprising:
a further phase shifter part coupled to receive two differently phased versions of said radio frequency signal and adapted to make said differently phased versions opposite in phase and to produce a sum of said differently phased versions made opposite in phase, and
a further detector coupled to receive said sum of said differently phased versions made opposite in phase, and adapted to produce a signal indicative of a magnitude of said sum of said differently phased versions made opposite in phase.
